(19) United States
(12) Patent Application Publication
(10) Pub. No.: US 2011/0174228 A1
(43) Pub. Date: Jul. 21, 2011

(54) HYBRID ANIMAL LITTER COMPOSITION

(75) Inventor: Qing LIU, Vienna, VA (US)

(73) Assignee: F&R ENTERPRISES, INC.

(21) Appl. No.: 13/011,474

(22) Filed: Jan. 21, 2011

Related U.S. Application Data
(60) Provisional application No. 61/296,996, filed on Jan. 21, 2010.
(60) Provisional application No. 61/302,551, filed on Feb. 9, 2010.

(51) Int. Cl. B01D 15/00; A01K 29/00

(52) U.S. Cl. 119/173

(57) ABSTRACT

A hybrid litter for pets and a method of making a hybrid litter for pets is provided. The litter includes a hybrid composition of inorganic clay, silica gel, and biodegradable materials, such as corn, wheat, alfalfa, peanut hulls, ground walnut shells, sawdust, and mixtures thereof and a low density mineral, such as perlite, diatomaceous earth, or pumice.

### RELATED APPLICATIONS

This application claims the benefit of priority on Provisional Application No. 61/296,996 filed Jan. 21, 2010, and Provisional Application No. 61/302,551 filed Feb. 9, 2010, the contents of which are incorporated by reference in their entirety.

### FIELD OF THE DISCLOSURE

This disclosure relates to litter for pets, such as cats, and to a method for making the litter.

### BACKGROUND OF THE DISCLOSURE

With the rise in popularity of cats as household pets, there has been an ever increasing demand for cat litter products that absorb the urine and fecal waste and control odor. Prior to the use of clay cat liners, cats had to either be kept outside or sawdust or sand was used for litter. The introduction of fullers earth clay liners brought the cat inside. Over time, sodium bentonite liners became popular due to their ability to form an easy to remove clump with the cat urine allowing all the waste to be removed for a cleaner and less odorous litter box. The cat litter market has evolved over time to consist of clay liners, both clumping and non-clumping varieties, liners made from biodegradable materials, and silica gel litters.

For clay liners, the most popular are the clumping kind made primarily from a gelling type clay, sodium bentonite. Fragrances and other odor control additives are often added to help control odor or leave a fresher aroma when the litter box is maintained. A disadvantage of sodium bentonite liners is the high density making these liners expensive to ship and being less convenient to the consumer to carry and remove the waste.

Biodegradable liners made from cellulose, wheat, corn, bamboo, pine, or other readily available organic material offer lower density, but are often deficient in odor control. Due to these types of liners being a food source for bacteria, they tend to produce more odor with cat urine and feces. Odor control, particularly the production of ammonia, is more of a problem than with the clay liners. These liners also do not clump as well as sodium bentonite and are often manufactured as large pellets or granules making them less acceptable to cats. Cats tend to prefer sand-like particles for litter.

The silica gel type litters often use a Type C silica gel, which has the optimized pore size for good odor control. These litters are very effective in absorbing high volumes of urine and controlling odor, but are typically more expensive than most litters. While they can be made to be cat acceptable, they are not generally clumping litters unless special additives are used.

Moisture absorbent particles, such as those used for animal lifters, have been made from moisture absorbent clay as described in U.S. Pat. No. 4,704,989. Clay fines are blended with an aqueous solution of lignin, lignosol, or lignin sulfate and the mixture is converted into partially dried, multi-faceted bulky aggregates through the action of a rotating agglomeration machine.

As described in U.S. Pat. No. 4,258,660, moisture absorbent pellets for use in animal litter have been made from bentonite clay binder plus finely ground straw.

A process for dewatering an aqueous dispersion of clay and agglomerating the clay into particles is described in U.S. Pat. No. 4,222,981. A hydrophobic organic bridging liquid and a liquid conditioner, which is effective for displacing water from the clay particles, are added to an aqueous dispersion of clay. With agitation, the clay particles agglomerate, are separated from the water, and dried.

U.S. Pat. No. 6,887,570 and U.S. Pat. No. 7,429,421 describe a process using a pin mixer and coating apparatus for producing a litter with a non-clumping clay inner core coated with a clumping sodium bentonite clay.

### SUMMARY OF THE DISCLOSURE

The present invention relates to animal litter, a new hybrid composition of natural ingredients used to absorb waste and control odor of pets, particularly cats. This invention consists of granules made of inorganic clay, silica gel, corn cob, corn meal, wheat, alfalfa, peanut hulls, ground walnut shells, pine sawdust, other soft and hardwood sawdust, or mixtures thereof, along with perlite, diatomaceous earth, pumice, or other low density mineral and a binder that serve as a means to absorb animal waste and odor associated with the waste.

This invention relates to a unique formulation and processing of a litter that includes ingredients from all three of these categories, clay, biodegradable material, and silica gel to produce a hybrid. It has been found that this type of hybrid provides synergy between the three categories mentioned. This invention offers the individual advantages of each category without some of the disadvantages. This new hybrid offers excellent clumping ability for easy removal of the cat urine waste, lower density than sodium bentonite litters, essentially no airborne dust, a biodegradable component, and micronized silica gel for excellent odor control.

In certain embodiments of the disclosure, a natural hybrid composition of animal litter granules comprises the following components:

(a) 50 wt. %-80 wt. % inorganic clay based on the total composition weight;

(b) 5 wt. %-15 wt. % micronized silica gel belonging to the class of silica gels of either Type A, Type B, or Type C as an odor control additive based on the total composition weight;

(c) 5 wt. %-20 wt. % corn cob, corn meal, wheat, alfalfa, peanut hulls, ground walnut shells, pine sawdust, other soft and hardwood sawdust, or mixtures thereof based on the total composition weight; and

(d) 8 wt. % -20 wt. % perlite, diatomaceous earth, pumice, or other low density mineral based on the total composition weight.

In certain other embodiments of the present disclosure a process for forming moisture absorbing granules is provided. The process comprises blending a mixture of 50 wt. %-80 wt. % inorganic clay; 5 wt. %-15 wt. % silica gel; 5 wt. %-20 wt. % corn cob, corn meal, wheat, alfalfa, peanut hulls, ground walnut shells, pine sawdust, other soft and hardwood sawdust, or mixtures thereof; and 8 wt. %-20 wt. % perlite, diatomaceous earth, or pumice, or other low density mineral based on the total composition weight in a blender to homogenize the mixture. After homogenization 20 wt. %-50 wt. % of a binder based on the total composition weight is added to the mixture to form particles. The size of the particles is increased by adding the homogenized mixture and binder to a high-speed rotary machine. The particles are coated by adding a powder to form granules. The granules are dried, by passing the granules through a rotary drier, to a final moisture content of 8-10% based on the total composition weight.

### DETAILED DESCRIPTION OF THE DISCLOSURE

The purpose of the present invention is to provide a high performance hybrid complex agglomerate of natural animal litter, such as cat litter. This new agglomerate, which not only readily forms clumps with urine for easy removal and odor control, has high absorption capacity with low density making it easy to handle.

The combination of inorganic clay with silica gel and a biodegradable natural material, such as corn, wheat, alfalfa, peanut hulls, ground walnut shells, or sawdust along with perlite, diatomaceous earth, or pumice and a binder was found to have excellent performance over other types of animal litter.

Accordingly, the present invention provides a new natural hybrid composition comprising the following ingredients:

(a) inorganic clay, which accounts for 50 wt. %-80 wt. %, and preferably 55 wt. %-75 wt. %, of the total composition weight;

(b) silica gel, which accounts for 5 wt. %-15 wt. %, and preferably 5 wt. %-10 wt. %, of the total composition weight;

(c) corn cob, corn meal, wheat, alfalfa, peanut hulls, ground walnut shells, pine sawdust, other soft and hardwood sawdust, or mixtures thereof, which accounts for 5 wt. %-20 wt. %, and preferably 10 wt. %-15 wt. %, of the total composition weight; and

(d) perlite, diatomaceous earth, pumice, or other low density mineral, which accounts for 8 wt. %-20 wt. %, and preferably 10 wt. %-15 wt. %, of the total composition weight.

The inorganic clay component is selected from at least one of the following: attapulgite, bentonite, kaolinite, sepiolite, or mixtures thereof. In certain embodiments, a preferred component is sodium bentonite.

Sodium bentonite is classified as montmorillonite clay. Montmorillonite is a layered hydrous aluminum magnesium silicate. Sodium bentonite has a negative electrical charge, large surface area, and cation exchange capacity. Another excellent feature of sodium bentonite is its adsorption/absorption properties allowing it to expand several times its volume when absorbing water.

In certain embodiments, the present invention includes silica gel, which is an amorphous material with the general chemical formula of SiO₂.nH₂O. It is insoluble in water and most solvents, non-toxic, odorless, and chemically stable. Various types of silica gel can be made from different manufacturing methods causing the formation of different pore structures. The pore structure provides good adsorption/absorption of odors. According to the size of the pores, silica gels are grouped into Types A, B, C, or D. All of these kinds can be used in this invention. In certain embodiments, Type C is preferred.

In certain embodiments of the invention, the binder component is 20 wt. %-50 wt. % of the total composition. In certain other embodiments the binder component is 25 wt. %-45 wt. % of the composition.

The litter of the present invention has a much lower bulk density than conventional bentonite litters. Conventional bentonite litters have a bulk density of 1000 -1100 grams Liter, whereas in certain embodiments of the invention, the litter has a bulk density of 400-800 grams/Liter. In certain embodiments, the litter has a bulk density of 600-800 grams/Liter.

In certain embodiments of the present invention a process for forming a new hybrid litter composition made from natural ingredients is provided. The process comprises the following steps:

### (A) Blending

(1) by total weight of the composition, 50 wt. %-80 wt. % of inorganic clay, 5 wt. %-15 wt. % of silica gel; 5 wt. %-20 wt. % of a biodegradable component, such as corn cob, corn meal, wheat, alfalfa, peanut hulls, ground walnut shells, pine sawdust, other soft and hardwood sawdust, and mixtures thereof; and 8 wt. %-20 wt. % of low density mineral, such as perlite, diatomaceous earth, or pumice are all added into the blender for homogenization.

(2) After homogenization, a binder component is added at 20 wt. %-50 wt. % of the total composition to form particles.

### (B) Particle Formation and Coating

The homogenized mixture and the binder is added into a high-speed rotary machine to increase the size of the particles. The preferred processing equipment to use is a rotating disc pelletizer. Granules are formed by coating the particles with a powder. A mineral powder is used to coat the particles. In certain embodiments, the mineral powder is selected from the group consisting of sodium bentonite, sodium montmorillonite, sepiolite, attapulgite, and zeolite. Alternatively, organic polysaccharide gum material, and mixtures of mineral powder and an organic polysaccharide gum material are used to form the coated granules. In certain embodiments, clay powder, preferably sodium bentonite, is used in the coating step.

### (C) Drying

The granule particles are then dried at high temperature to the desired moisture level, preferably 8-10%.

In certain embodiments of the invention, the granules are dried at higher temperatures than in conventional drying methods. For example, in certain embodiments of the invention, the granules are dried in a rotary drier. The temperature at the entrance to the rotary drier is controlled to be about 170° C. to about 250° C. and the temperature at the drier exit has a higher temperature of about 500° C. to about 700° C. Whereas, in conventional drying techniques, the drier entrance temperature is 180° C. to 250° C. and the drier exit is at a lower temperature, 100° C. to 120° C.

In embodiments of the invention, the higher temperature towards the end of the drier allows water vapor to continuously flow in the opposite direction to exit through the imput. This reverse heating profile provides a more even distribution of heat. In addition, at temperatures of 300° C. to 400° C., water vapor has an expanding effect on the pores inside the clay ingredients. Because the pores become wider, the effect is that the absorption rate greatly increases. For example, the hybrid litter according to the present disclosure achieves an absorption rate of 90-110% using the conventional heating tunnel. On the other hand, when the granules are dried in a rotary drier in which the exit temperature (about 500° C. to about 700° C.) is higher than the entrance temperature (about 170° C. to about 250° C.), the absorption rate increases to 250-350%.

The absorption rate is determined using a water straining experiment. 40 ml of water is poured onto 10 g of material packed into a funnel. When water flows through the funnel, the material is saturated, and the increase in weight of the material is measured and is divided by original weight to find the absorption rate.

Table 1 lists typical properties of the final granule product.

TABLE 1
Performance Testing and Product Specifications

| Property | Result | Method |
|---|---|---|
| Impurities | None | Visual Check |
| Odor | None | Sense of Smell |
| Color | White to Tan | Visual Check |
| Granulometry | 0.5-2.8 mm | Standard sieve |
| | | analysis |
| Bulk Density | 400-800 g/L | Material dropped |
| | | freely into 100 ml |
| | | graduated cylinder |
| | | and weighed |
| pH | less than or | 5.0 g of product |
| | equal to 8.5 | placed in 25 ml |
| | | distilled water and |
| | | checked after 15 min |
| | | with standard pH |
| | | paper or instrument |
| Granule Integrity | Not broken | Observation of |
| | | granules placed in |
| | | water |

This lightweight animal litter made from natural ingredients offers an advantage over other clay litters, silica gel litters, and litters made from biodegradable materials. This litter includes the advantages of each of those types of litters in one product. It has been found that the unique combination of clay, silica gel, a biodegradable material, and a low density mineral along with a binder provides a synergistic effect resulting in granules with much improved properties over what could be made from each of these materials separately. The litter is very absorbent, forms strong clumps with urine for easy removal, has good odor adsorption and thereby good odor control, and is lightweight. It satisfies the desire to have the functional capabilities of odor control and lower density while also containing a biodegradable component.

In the foregoing description, certain terms have been used for brevity, clarity, and understanding, but no unnecessary limitations are to be implied therefrom beyond the requirements of the prior art. Moreover, the embodiments of the composition illustrated and described herein are by way of example, and the scope of the invention is not limited to the exact details of formulation.

What is claimed is:

1. A natural hybrid composition of animal litter granules comprising the following components:
(a) 50 wt. %-80 wt. % inorganic clay based on the total composition weight;
(b) 5 wt. %-15 wt. % micronized silica gel belonging to the class of silica gels of either Type A, Type B, or Type C as an odor control additive based on the total composition weight;
(c) 5 wt. %-20 wt. % corn cob, corn meal, wheat, alfalfa, peanut hulls, ground walnut shells, pine sawdust, other soft and hardwood sawdust, or mixtures thereof based on the total composition weight; and
(d) 8 wt. %-20 wt. % perlite, diatomaceous earth, pumice, or other low density mineral based on the total composition weight.

2. The composition of claim 1, wherein component (a) is selected from at least one of the group consisting of attapulgite, bentonite, kaolinite, sepiolite, and mixtures thereof.

3. The composition of claim 2, wherein component (a) is bentonite, attapulgite or mixtures thereof.

4. The composition of claim 3, wherein component (a) is bentonite.

5. The composition of claim 1, comprising 55 wt. %-75 wt. % of component (a).

6. The composition of claim 1, comprising 5 wt. %-10 wt. % of component (b).

7. The composition of claim 1, comprising 5 wt. %-15 wt. % of component (c).

8. The composition of claim 1, comprising 10 wt. %-15 wt. % of component (d).

9. The composition of claim 1, further comprising 20 wt. %-50 wt. % of a binder component based the total weight of the composition.

10. The composition of claim 9, wherein the binder component is selected from the group consisting of water, silica sol, sodium silicate, dextrin, and mixtures thereof.

11. The composition of claim 1, further comprising titanium dioxide as a whitening agent and photocatalyst.

12. The composition of claim 1, wherein the bulk density of the composition is 400 grams/Liter to 800 grams/Liter.

13. A process for forming moisture absorbing granules comprising:
(A)(1) blending a mixture of 50 wt. %-80 wt. % inorganic clay; 5 wt. %-15 wt. % silica gel; 5 wt. %-20 wt. % corn cob, corn meal, wheat, alfalfa, peanut hulls, ground walnut shells, pine sawdust, other soft and hardwood sawdust, or mixtures thereof; and 8 wt. %-20 wt. % perlite, diatomaceous earth, or pumice, or other low density mineral based on the total composition weight in a blender to homogenize the mixture;
(A)(2) after homogenization adding 20 wt. %-50 wt. % of a binder based on the total composition weight to the mixture;
(B)(1) increasing particle size by adding the homogenized mixture and binder to a high-speed rotary machine;
(B)(2) coating particles by adding a powder to form granules; and
(C) drying the granules by passing the granules through a rotary drier to a final moisture content of 8-10% based on the total composition weight.

14. The process of claim 13, wherein in step (A) each component is added in its respective proportion at the same time and blended for homogenization.

15. The process of claim 13, wherein the powder is selected from the group consisting of mineral powders, organic polysaccharide gum material, and mixtures of mineral powder and an organic polysaccharide gum material.

16. The process of claim 15, wherein the mineral powder is selected from the group consisting of sodium bentonite, sodium montmorillonite, sepiolite, attapulgite, and zeolite.

17. The process of claim 13, wherein in step (C) the temperature at the entrance to the rotary drier is about 170° C. to about 250° C. and the temperature at the drier exit is about 500° C. to about 700° C.

18. The process of claim 13, wherein the final composition is used as a sanitary treatment of animal waste.

19. The process of claim 18, wherein the animal waste is cat waste.
